(19) United States
(12) Patent Application Publication
(10) Pub. No.: US 2017/0011113 A1
(43) Pub. Date: Jan. 12, 2017

(54) System and Method for Identifying Users on a Network

(71) Applicant: GeoCommerce Inc., Irvine, CA (US)

(72) Inventors: Jeff Sparrow, Tustin, CA (US); Mark Sullivan, Clovis, CA (US)

(21) Appl. No.: 15/271,016

(22) Filed: Sep. 20, 2016

Related U.S. Application Data
(63) Continuation of application No. PCT/US2015/021885, filed on Mar. 20, 2015.
(60) Provisional application No. 61/968,211, filed on Mar. 20, 2014.

(51) Int. Cl. G06F 17/30

(52) U.S. Cl. CPC G06F 17/30598; G06F 17/30241; G06F 17/3087; G06F 17/30887

(57) ABSTRACT

System and method described herein may be used to relate a physical address of a user and an IP address of a user from on-line exchanges of the user. The method may include relating an IP address to an intermediate identifier, where the intermediate identifier is observed with the IP address during a single on-line exchange. The method may also include relating the physical address of the user to the intermediate identifier after an observed correlation between the physical address and the intermediate identifier. The method may also include relating the physical address of the user and the IP address of the user, where the physical address and the IP address are not observed together in a single on-line exchange.

### CROSS REFERENCE TO RELATED APPLICATIONS

This application claims priority to U.S. Provisional Application No. 61/968,211, filed Mar. 20,2014, titled “On-Line Direct Response Platform,” which is incorporated by reference herein in its entirety.

### TECHNICAL FIELD

The present disclosure is directed toward methods and systems for identifying a specific user on an Internet network through empirical observation of user information, such as geographic location, public information, and persistent and semi-persistent identifiers included in network communication logs, and user files.

### BACKGROUND

It may be desirable to identify specific users or associated attributes about a user during their engagement and navigation of on-line experiences.

The prevailing online user tracking methods rely on cookies and clicks. The problem is that these browser-based methods are unable to reach unique users or to provide verified accuracy. Not long ago cookies were effective in increasing click throughs, but results have steadily dropped off. It turns out that the cookie's tracking abilities are limited in important ways because of blocking, expiration, and privacy.

Cookies are currently blocked half the time, making is impossible to identify and track individuals online. Add to this limitation the fact that most cookies time-out and disappear after a number of days. What happens to the connection between the consumer and the data related to a series of clicks stored by a vanished cookie? It vanishes, too. And now regulators are working to enact more stringent “Do Not Track” and “Do Not Collect” legislation that could prevent, or seriously restrict, the use of cookies in many cases.

If these limitations were not enough, there is another major flaw with tracking cookies. Each cookie is supposed to represent a unique user, but usually every user is collected to 3, 5, or even move cookies. So there's no way to really know whether a unique user connected to one cookie is the same unique user connected to another. Clearly, cookies and clicks are incapable of truly identifying and tracking individuals online.

Convention methods for tracking a user are insufficient to identify a full range of user activities, across multiple machines, from multiple locations, etc. The conventional methods are limited to the activities of the user while they are within a single browser, on a single machine, during a single navigation of one or related website(s), only for a limited time frame, and any combination thereof and others. Some present systems may also associate a user by ISP data, which may have inaccuracies up to 25 miles, machine (MAC) addressing (which identifies an owner or machine, but not a user) or to a billing address (which does not necessarily correlate to any physical address or location of the user or distinguish multiple users sharing a common billing address).

### BRIEF SUMMARY

Exemplary embodiments described herein may include targeting technologies that do not rely solely on browsers, cookies, and clicks to identity unique individuals. Exemplary algorithms may map offline and online data to cross-reference geographical location and web entry location. This relationship may have multiple benefits and uses, such as correlating a specific physical address to a user's internet access point.

Exemplary embodiments comprising a hyper-targeted, geo-location technology combined with census and other demographic data produces a highly accurate and verified profile of a unique internet user within a household or business location.

### BRIEF DESCRIPTION OF THE DRAWINGS

FIGS. 1A and 1B illustrate an exemplary system and platform for correlating, obtaining, relating, retrieving, and using user information in an efficient and coherent manner.

FIG. 2 illustrates an exemplary visual representation of a spatial database that relates persistent and semi-persistent data objects of a user to a specific point by observing networked activities.

FIG. 3 illustrates an exemplary geographic area such as a neighborhood.

FIG. 4 illustrates an exemplary algorithm and method of relating an IP address, street address, and other data objects associated with a user and/or device.

FIG. 5 illustrates an exemplary embodiment of a client-server network environment to implement embodiments described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. If should be understood that the drawings are diagrammatic and schematic representations of exemplary embodiments of the invention, and are not limiting of the present invention nor are they necessarily drawn to scale.

Embodiments described herein use a multiple point relationship between static and semi-static data pieces obtained during a user's experience with networked transactions to identity and track the use of the individual user.

Although embodiments of the invention may be described and illustrated herein in terms of relating an IP address of a user to the user's physical address, it should be understood that embodiments of this invention are not so limited, but are additionally applicable to bridging a data relationship to any identifier of a user, device, related entity or object, or point. Furthermore, although embodiments of the invention may be described and illustrated herein in terms of marketing to a user, it should be understood that embodiments of the invention are also applicable to other internet applications, such as identifying users, identifying non-users, statistical observation and analysis, observing device movements, and identifying, observing, analyzing, and/or manipulating any number of user statistics, information, uses, habits, etc.

Embodiments described herein may be used for identifying a specific user on an Internet network through empirical observation of user location, public information, and user network actions. Accordingly, a database may comprise unique internet users and correlate One or more user information data objects, such as IP address, phone, email, postal address, latitude/longitude address, device ID, cookies, or other persistent or semi-persistent identifiers. Once one or more pieces of information regarding the user is known, a search algorithm may be used to provide one or more other pieces of desired information about that user. The desired information may be information directly saved in the database or information obtained from other information saved in the database. Thus, the database may include specific user information correlating the different information data objects to specific users. General information correlating one or more data objects from a user to general consumer information may also be stored in the database to then correlate or statistically speculate about one or more attributes of the specific user once the specific user is identified.

In an exemplary embodiment, the pieces of user information are related to a user location as a basis of confirming identity. Therefore, information related to an IP address may be related to one or more user physical addresses, such as home or work. When other user information is associated with the IP address, that information is also related to a physical address. Then, when the IP address changes, but the relation to the physical address is reinstated, the information from the previous IP address may be linked through the physical address to continue the user profile. Other user identifiable information may be used to associate any transaction to a specific user. For example, IP address, phone, email, physical address, devices, or an assigned persistent identifier, among others. Therefore, exemplary embodiments described herein may be used to replace or update the relationship whenever one or more of the persistent or semi-persistent identifiers is changed.

Embodiments described herein may be used to correlate any one piece of information to any other piece of information in the same relationship. For example, any one or more pieces of user information received may be used to generate or provide any other desired piece of information. In an exemplary embodiment, a user may be identified through a search profile created to identify one or more pieces of information, such as IP address, phone, email, postal address, physical location, device, cookies, or other persistent or semi-persistent identifier, from any one or more other pieces of information. Accordingly, a user may select whatever desired combination of information relevant to them by receiving any one or more other pieces of information available during a transaction of a user on the internet.

Conventionally, a company or provider may request that a user allow cookies to be saved on their computer. A cookie is saved at the user's browser or on the user's machine, and is requested by and sent to a website of the associated company setting rise cookie. The cookie then informs the website of the user's previous history or activity. The cookies are used as a mechanism to store and retrieve long-term records of an individual's navigation and usage history. Thus, the use of cookies permits a website and associated owner of the website to recognize individual customer's by their previous transactions and on-line activities. This data can then be used to suggest items to the user, store items in a shopping cart, store passwords, associate auto-form-fill fields.

However, the use of cookies to track a user's history is limited, as the user must permit or authorize cookies to be stored on their machines, and cookies may be erased by the user at any time. Moreover, cookies are only associated with the combination of a user's account, a computer, and a web browser. Therefore, cookies are not associated with the user and if multiple machines, devices, or even browsers are used by a user, then the full history of a user's transact ions are not recorded. A number of devices and machines, such as smart phones, do not support the use of cookies, while some gateways and networks will strip or simulate cookies. Thus, the use of cookies is not a reliable method of obtaining a user's history.

IP addressing is an alternative method presently used to track activity of a user. The IP address is generally provided during the communication of the device to the server to engage in the requested on-line transaction. However, IP addressing may change with a reconnection to a network, such as if a server were rebooted. Many computers and/or users may share a single public IP address through a network address translator (NAT). Some systems are also designed to retain anonymity rendering tracking by IP address impractical or impractical.

Traditionally, the IP address was not a tracked data object as the IP address was unstable. The IP address can change because of a power outage, removing a modem power source, rebooting a modem, or resetting the modem features. There were no indicators that the IP address for any given device was about to change, or any notice that a change actually occurred. Moreover, for a power outage example, the IP addresses of essentially all of the users in the area affected by the outage would be changed at once. Therefore, the stability of the IP address made it an undesirable data object to identify.

An internet Service Provider (ISP) assigns the IP address and could identity an association between the assigned IP address and corresponding postal address. However, the ISP has instead chosen to randomly assign a group of IP addresses to any requesting device from a pool of available IP addresses. From a regulatory perspective, ISP companies were threatened with the thought or notion that if IP addresses were assigned or logged to a specific postal address in use, then the ISP would become a repository for law enforcement and private investigations to determine the ultimate originator of activity associated with any given IP address. Therefore, to minimize the total number of necessary IP addresses for the maximum number of users, to prevent a repository of IP addresses to users and the interference to the ISP business in handling requests for such information, and for any perceived benefit of making the association, no company, and especially not the ISP, have associated IP addresses to postal addresses. Instead, the ISP provide a block of available IP addresses that are distributed as necessary to requesting users and devices.

Unique uniform resource locator (URL) strings may also be used similar to a cookie. Unique URLs may embed information into the URL to be passed from the web browser to the web page and uniquely identify the source at that transaction. In use, the web server attaches a string to a website link when sending it to a browser. When a user follows the link, the browser returns the same string back to the server, thus identifying the same user. However, the user is identified only if they access the server or website through the provided link. For example, if a user independently searches tor the website through a search engine, then that session will not be identified as the same user. Alternatively, if the link is shared between users, such as if a link is emailed among many users, the server would recognize each of the users by the same unique URL identifier and not delineate activity among the users.

Authentication may also be used to identify a user and thereafter track their activity on the respective site. Instead of using cookies or other mechanisms to identity a user, a website or provider may require a user to log in with unique identifiers and/or passwords. Once authenticated, the server and browser requests can store and send a unique identifier associated with that user in subsequent page requests. However, a user must register with a website and permit the provider to follow their actions. The actions of the user are only observed while they are behind the authentication.

The conventional methods of tracking a user's activities on networked devices have generally been isolated, such as by device, transaction session, or browser. For example, conventional methods only observe individual or single transactions or activity sessions, but do not relate the activity of the user to a larger extent or across devices or activity sessions. Moreover, some identifiers may be deleted or reset without any way of retaining or relating a new identifier to the previously tracked activity.

Therefore, associating and tracking larger groups of identifiers has traditionally been seen as too computationally expensive or too unreliable over any period of time. Moreover, the time lag associated with making various informational connections, refreshing semi-persistent identifiers, and creating relationships among various independent organizations makes relating different data pieces or informational connections regarding a single user inefficient and impractical. Therefore, it has traditionally been seen as most cost efficient to identify and request a user's permission to individually track the associated information desired by a given company at the risk of having to restart that identification if the persistent identifier, such as when a cookie or IP address, is reset. Relating information by communicating between a number of these companies to create a comprehensive information set about a user is computationally expensive, requires cooperation between unrelated and potentially adverse entities, imposes a substantial time lag to traverse the overlapping data points from individual data logs to get from a first identifier of one log to another identifier of another log, and is difficult to maintain if any semi-persistent identifier is refreshed.

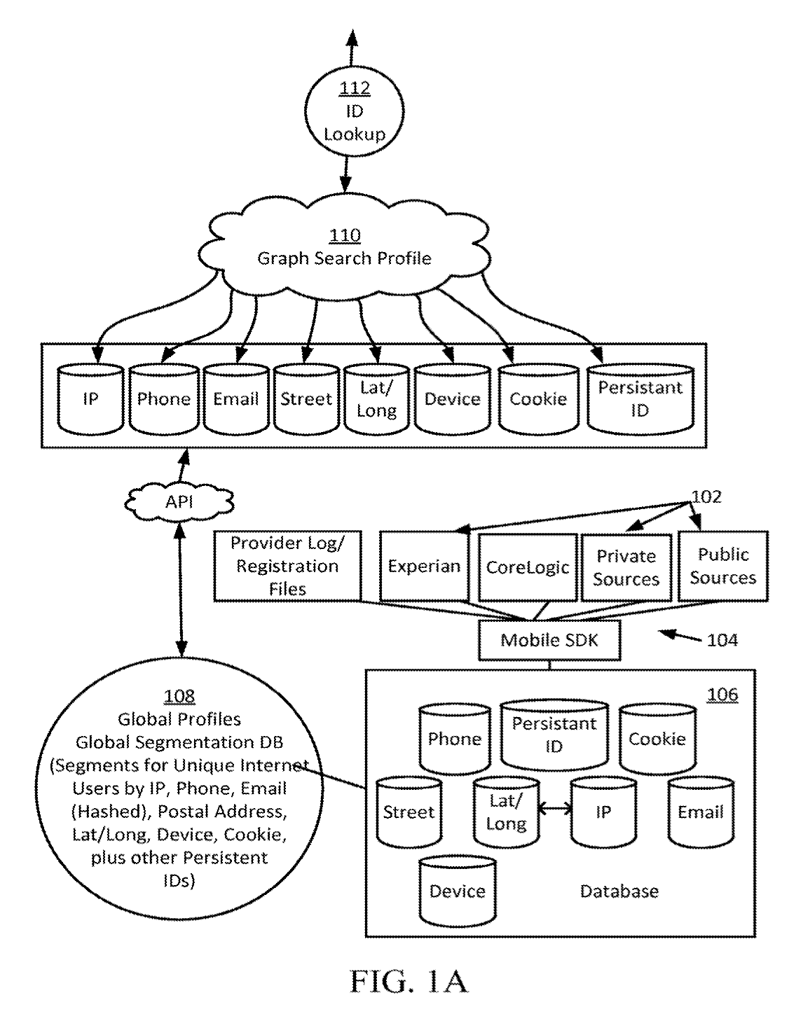

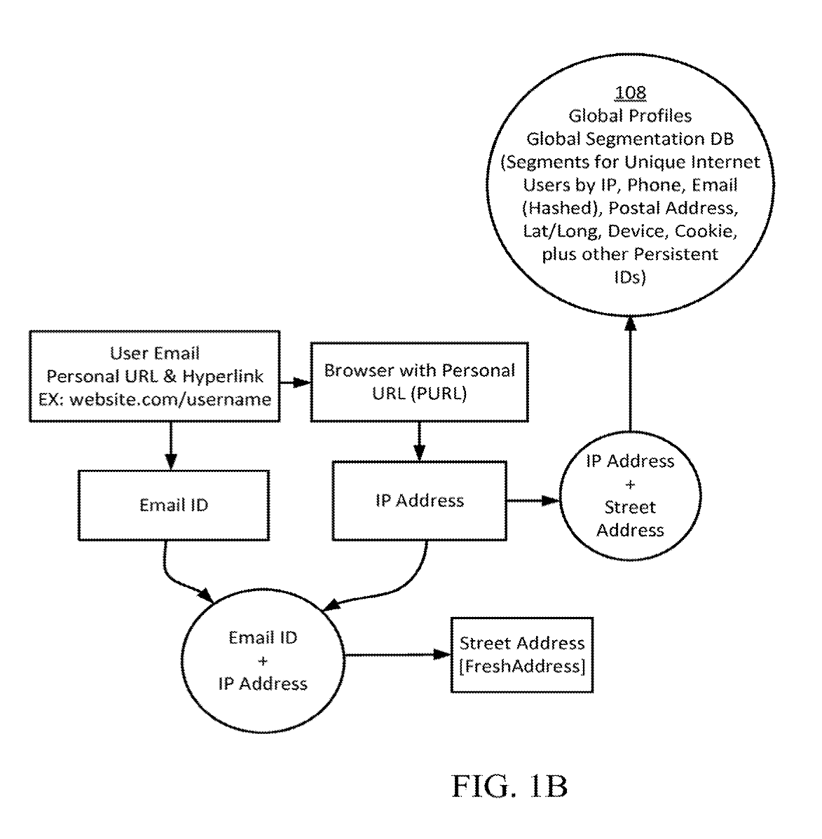

FIGS. 1A and 1B illustrate a system and platform for correlating obtaining, relating, and using user information in an efficient and coherent manner. The system interacts with a number of information sources 102 that obtain information about a user, the user's devices, identifiers of the user, the user's activities, and combinations thereof. The system then obtains, compiles, relates, and uses that information to the provide relevant information quickly and conveniently to sources engaging with that user.

The information sources 102 may be from providers of services or products, public databases, or other sources that obtain, track, log, observe, or otherwise have persistent or semi-persistent information. These sources, for example may be web-sites or providers that obtain user information or user identifiers, such as cookies, to track or identify a user on the internet. Providers may be an entity that hosts or provides an application, such as a game, that obtains user consent to observe certain data transmissions from the user while engaging in the application. The provider may also obtain information from a user through registration, such as form filing, login, account creation, or association through another account or identifier, such as e-mail, social sites, etc. Therefore, the providers may obtain user information directly from user input (e.g. registration files) or through passive observation of user data transmissions (e.g. use or log files). For example, a provider such as Experian may keep track of a user's IP address to an assigned cookie saved to the user's browser. Experian may then use the cookie to identify when a user visits their site. Another exemplary information source is data providers, such as CoreLogic, which is a large data provider that includes geospatial parcel data, credit information, property and tax data, mortgage and asset information, etc. Other public sources of user information may include databases of physical addresses such as residence, work, or social profiles through social media available on the internet.

The system then interfaces with the multiple information sources 102 to obtain the desired information in an appropriate relationship 106. For example, through one or more application programming interfaces, the system can specify how the different information sources provide data to an exemplary spatial database 106. As shown, a software development kit 104 is used to create the applications or software framework for retrieving, observing, or compiling the desired information from the one or more information sources and save the respective information in the desired format in a database 106. The system may be updated at regular intervals by merely confirming the presence of one or more of the identifiers when information is passed, such that the entire method of relating information need not occur at each data transmission.

The database 106 may be segmented or used to create profile databases 108 to provide specific relationships of desired information. The segmented database 108 may be in a form that is more efficient to search, and/or requires less bandwidth or memory to maintain or send. The segmented database 108 may also encrypt or hash one or more of the data objects to maintain anonymity or confidentiality. The segmented database may then be searched based on given information for desired associated information.

For example, a lookup 112 may be perforated by entering a known identifier into a profile search engine 110. The search engine 110 may search on any identifier that is saved to the system, such as those attributes in the segmented database 108 extracted from the identifier database 106. The engine may use an application program interface (API) to search on the given criteria and return the desired data object(s). The API may also be used to decrypt the information of the segmented database or perform the hash function of one or more of the data fields to retrieve the desired information.

In an exemplary embodiment a Device Identifier Graph Profile provides a method for identifying a specific user on an Internet network through the empirical observation of unique and persistent or semi-persistent identifiers for identifying and monitoring a specific device on a specific network. A system of unique keys, for example alpha-numeric descriptors, may be used to identify, encrypt, or alter the identifiers that may be periodically updated to ensure the anonymity of the user and associated identifiers by outside observers.

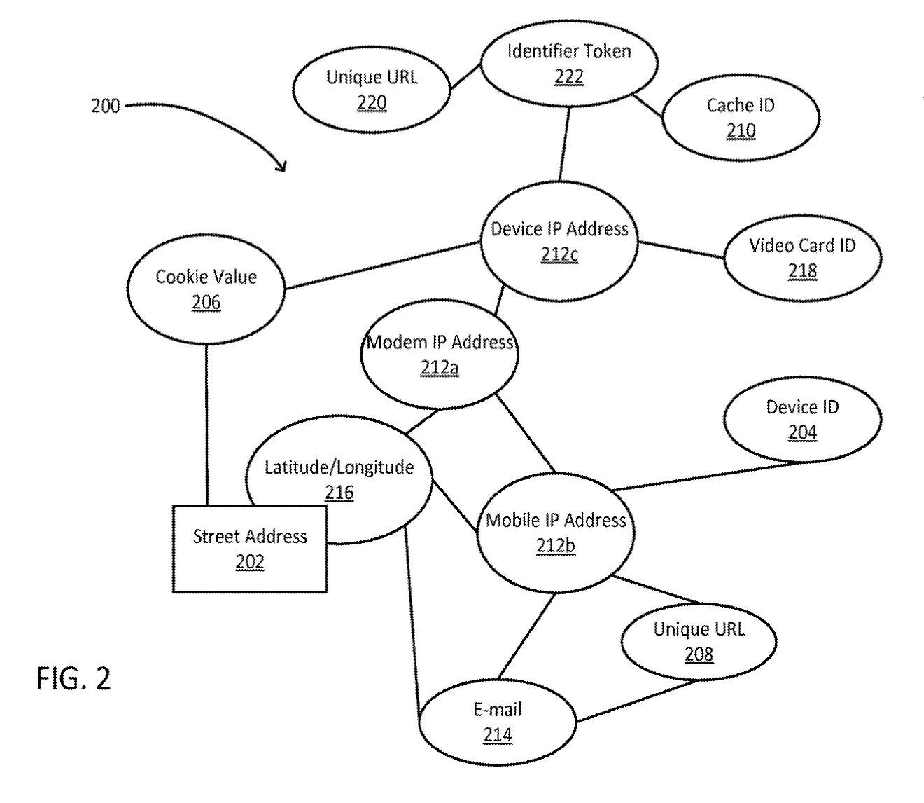

FIG. 2 illustrates an exemplary concept of a spatial database 200 that permits various static and semi-static data pieces of a user to be related to each other or a single identifier, such as a physical address of that user, by observing networked activities. As shown, each of the data pieces may be related together by the occurrence of each piece relative to another data piece. In an exemplary embodiment, the spatial database 200 may be the relational database 106 of FIG. 1A.

The exemplary spatial database consists of objects. The objects have an individual value in relation to a particular point. As an occurrence of the object appears with respect to that point, its individual value is increased. Conceptually, the objects may be any data piece, such as the Street Address 202, Device ID 204, Cookie Value 206, Unique URL 208, Cache ID 210, IP Address 212, E0Mail 214, Latitude/Longitude 216, Video Card ID 218, or any other device or user identifier or associated information. The particular point may be, for example, another object, a static identifier, or any arbitrary unknown or known point. The described spatial database may be a graph profile type dataset where the graph profile is essentially the particular point of interest and other graph objects are related to the particular point.

As information and traffic is observed to and/or from a device, the spatial data architecture of the respective objects is updated base on the objects occurrence or presence with respect to the particular point. In essence, a relationship score associated or correlated to how frequently an object shows up in relation to a particular point. The particular point may be another object, or may be a static identifier, such as a location expressed as latitude/longitude or postal address or other physical address. Therefore, as an object is identified with respect to a particular point its frequency or relational score with respect to a particular point is increased and its weight against that particular spatial object is closer. As objects are related to each other, an association or strength can be correlated between the respective objects. Accordingly, any one object may be used to determine a value of any other object may relate through the spatial data architecture.

Embodiments as described herein are described in terms of the particular point being either a physical location, such as latitude/longitude or street address, and/or IP address. However, any object, static data, semi-static data, or other location or identifier may similarly be used alone or in combination. In addition, one or more spatial databases may be used. For example, a first spatial database may relate one or more objects to a physical location, such as the street address, while a second spatial database may relate one or more other objects to the IP address. The one or more objects from each database may be the same, different, or a combination thereof.

In searching the exemplary spatial databases, when an occurrence of an object is seen, such as from passively observing a raw feed of transmission data, that data piece may be looked up in the spatial database. Any one or more data pieces from a raw feed may be used to look up associated information in the spatial database. For example, those objects that have a relationship weight to either an IP address or physical address may be used as look up data pieces in the spatial database.

For example, when IP Address 212 and E-mail address 214 are identified in a networked transaction together, the relationship between these data pieces grows stronger and the relationship from one to the other is given a higher confidence level. As illustrated, the confidence level is indicated essentially by the separation distance of the respective data pieces. The line connecting pieces illustrates that an occurrence relationship occurred between these data objects, and the line is shortened each time the objects appear together or as associated. As data pieces are identified or confirmed together, their relationship increases. If any data piece is terminated or reset, the association with a replacement data piece of that same identifier will migrate toward the other data pieces as occurrences are associated. Thus, any one or more data pieces may be used to identity any one or more other data pieces or the user.

In an exemplary embodiment, the system is configured to observe data or traffic over a connection. One or more of the observed data pieces are related in a multi-point relationship to one or more other data pieces observed through the same or other data streams and/or connections. The data pieces are stored in a multi-point relationship in a database to relate and identify various static or semi-static data pieces.

An exemplary data piece that may be saved as an object in the spatial database is a physical address. The physical address may be expressed as a specific location within an exemplary addressing system. For example, street addressing or postal addressing may be used to identify a physical address within a desired accuracy associated with the area of the lot allocated to the given address. The address may be a more specific location within a given grid or segmented region. For example, latitude and longitude coordinates may be used to identify a specific physical address. Other location methods may be used, such as parcel data, proximity to a location/etc. Physical address is meant to include an identifiable or referenced system of the user's location or location related to the user, such as, for example, postal address of a resident, postal address of a work, latitude/longitude location, GPS coordinate, actual present, past or future location of user, relative location, boundary location, area location, and any combination thereof.

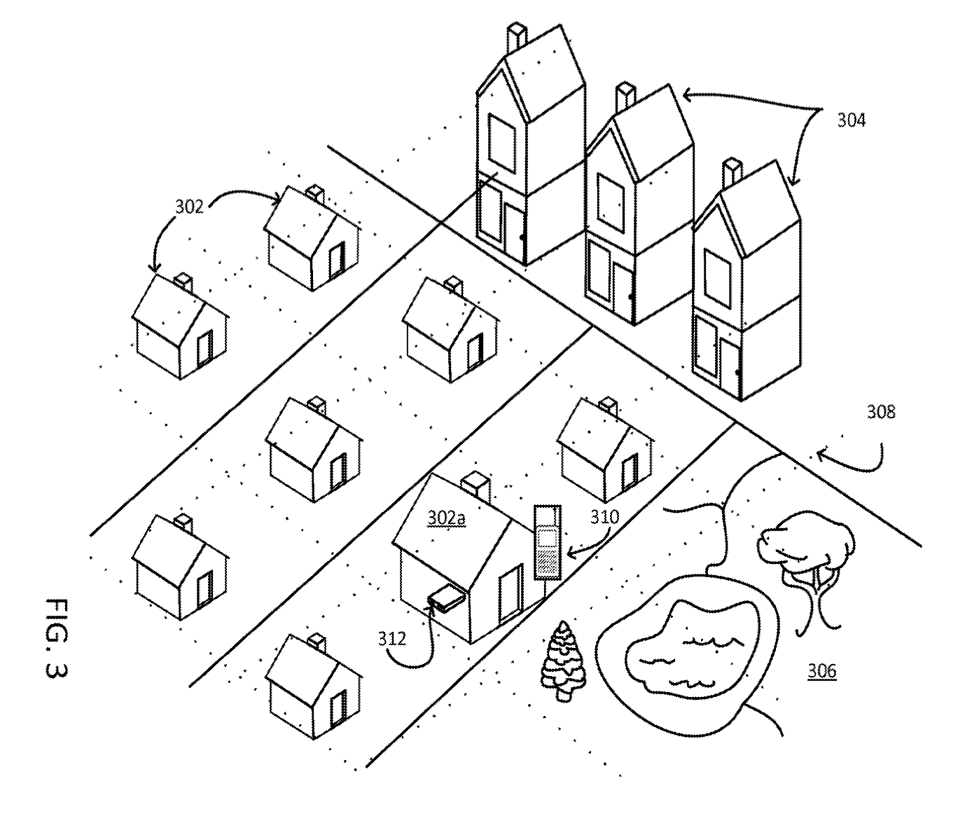

FIG. 3 illustrates an exemplary geographic area such as a neighborhood. The geographic area includes a number of houses 302 and other structures 304. The other structures 304 may be office space, town houses, apartment complexes, etc. Other land locations 306 may also be present in the geographic area. Land locations may be other allocations not associated with a structure, such as, for example, parks, wildlife preserves, ponds, playgrounds, pools, etc. Each structure 302, 304 or land location 306 has a given address. The address is a unique identifier given in a combination of increasingly specific identifiers such as number, street name, city, state, and zip codes. Any one or more of these location identifiers may be used as location data.

Each location is similarly identified by a grid location indicated by latitude and longitude. The latitude and longitude are imaginary grid lines that subdivide the Earth. These grid lines may or may not coincide or align with one or more of the address identifiers. However, each parcel or lot associated with a street address can be correlated to a set of latitude and longitude coordinates encompassed by that address location.

Referring back to FIG. 2, the association between the coordinate latitude, longitude 216 and a street address 202 are essentially set by the defined known relationship. Accordingly, these two data objects are essentially on top of each other indicating a strong weighted relationship. This relationship is temporally almost permanent since once an address is assigned to a parcel, that parcel, its address, and associated latitude and longitude that parcel encompasses is generally static. In other words, once assigned, parcels and addresses are generally not redefined that often unless and entire area is under redevelopment. Therefore, if one of these data objects is known, the other object is known with a very high degree of certainty.

Most mobile devices 310 have a global positioning system (GPS) which locates the device according to the latitude and longitude of its location. This information may be broadcast with various data streams. Therefore, the latitude and longitude of a mobile device is generally known. This specific location data may be correlated through a database or other association of latitude/longitude to physical address to obtain the present physical address of the mobile device. Similarly, once the street address is known, the identity of the location may be determined through public records and may be related to a physical address, such as a postal address. For example, if the address is a business, the identity of the business may be identified.

Once the physical address is identified, other geographic or demographic information may be correlated through the physical address. For example, if an address is residential, then the actual or estimated house price may be known. Other information may include, for example, the median house price of the location, likely household income ranges, school districts, political affiliations, nationalities, etc. If the physical address is a business, then the type of work performed, such as industrial, manufacturing, general office, retail, etc. may be estimated. These associations may be made through private or public data sources maintained on various geographic locations.

The time of any transmission can also easily be obtained either directly from a data stream or by merely referencing tin independent time source at the time of a data transmission. Therefore, any data observed during a transaction can be time stamped. The time a transmission is made can provide additional information about the obtained data. For example, if a transmission is made generally during the sleeping hours of 1:00 A.M. and 4:00 A.M., then the associated address or latitude and longitude obtained during that time will likely be au address where the user sleeps, such as a home address.

The duration the same data object is observed may similarly indicate additional information about the received data object. For example, if a location is observed only once in a given sequence of data transmissions, then the user associated with the mobile device is likely in transit between locations. However, if a person is at a location for longer than a threshold time, such as, for example, an hour, two hours, or more, then the associate location is likely one in which the user engages in a prolonged activity, such as eating, working, exercising, entertainment, etc. The time stamp may similarly be used in conjunction with the duration to estimate activities. For example, if a person is at a location between 9:00 A.M. and 11 A.M. and/or 2:00 P.M. to 3:00 P.M., then the location is likely a business address associated with the user.

The frequency of the same data object during a given time interval may indicate additional information about the received data object. Similar to the time of day, if the user is at the same location on a regular basis such as on sequential days or on some identifiable schedule, then the relationships of that location to the user can be estimated. Therefore, if the same address appeared associated with a user every day for a given time period, such as a month, then that address may be associated with the user's residence. However, if a user is only at an address four or five out of seven days within a week, then that address may be a work address.

In an exemplary embodiment, the system is configured to save a data object to the spatial database that includes a physical location. The physical location may be identified through the GPS of a mobile device, such as latitude and longitude. The system may then be configured to correlate the physical location, such as GPS or latitude and longitude, to a street address or identifiable parcel of land. Further, the system may be configured to obtain additional information about the data object by observing the time of day the mobile device was associated with the data object, the duration the data abject was observed associated with the mobile device, and/or the frequency in which the data object is observed from the device. For example, the physical location may be identified as a residence or work address of the user of the mobile device. Day-parting, frequency, and duration may similarly indicate associated information about other data objects not just the physical location of a mobile device.

In an exemplary embodiment, data, objects, such as those identified in FIG. 2, may include physical locations such as latitude and longitude 216 obtained through GPS and correlated to a street address 202. One or more of these physical locations may be associated together and separately identified. For example, an address identified as a business address may be observed from the same device associated with an address identified as a residence address. Therefore, the business and residential address of the mobile device user may be achieved. The system is configured to identify other data objects about the user from tire physical location data object. For example, statistical demographic information about the user of the mobile device may be correlated to the user through the street address data object.

The Internet Protocol (IP) address, data object 212, may also be observed and correlated during data transactions. For example, when a mobile device connects to a modem of a wireless Local Area Network (LAN) such as WiFi, the authentication process creating the connection broadcasts the location, IP address of the modem, and the IP address of the mobile device. For example, as seen in FIG. 3, a mobile device 310 may generally broadcast over the wireless phone network to receive data signals tor performing on-line functions, such as searching the internet, playing music or games, etc. Once the mobile device 310 approaches a location 302a with a WiFi modem 312, the mobile device 310 may automatically authenticate or may request the user to access the WiFi modem. In either case, the mobile device user has entered or is prompted to enter credential information such as modem identifier, login name, and/or password, and authorization to access the network through the WiFi modem 312. During the authentication process, the data stream communication between the mobile device 310 and the modem 312 transmits the mobile location through a physical address of latitude/longitude 216, IP address of the modem 212a, and the IP address of the mobile device 212b. The correlation between these data objects, such as shown in FIG. 2, is therefore increased.

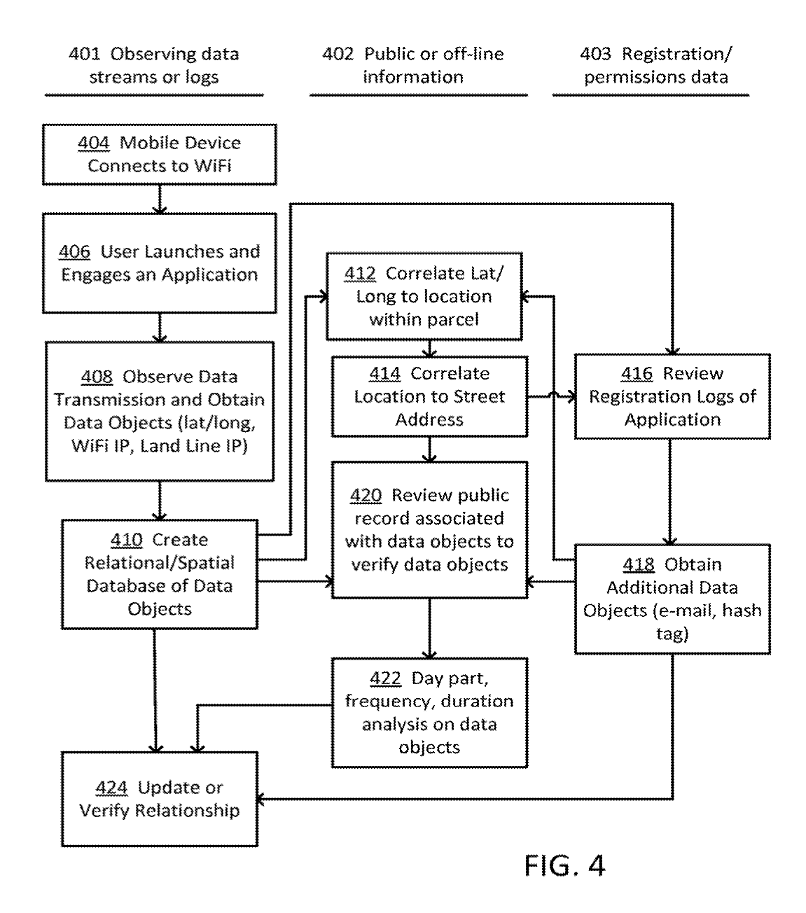

Referring to FIG. 4, an exemplary method of relating an IP address, street address, and other data objects is illustrated. In an exemplary embodiment, IP addresses are tracked and associated to other data objects in related datasets. For example, the data objects appearing with a given IP address are tracked and those that remain persistent or semi-persistent are determined. The spatial database as described herein may be used to associate or determine the persistence or semi-persistence of related data objects.

In an exemplary embodiment a mobile device transmits data streams from the device to a remote server. In a first phase, 401, the data streams or logs associated with the data streams are used to observe, relate, and save data objects. Observation includes direct monitoring of data streams as the data is transmitted to and from the device, as well as reviewing or observing logs of select data from or about the transmission to or from a device. The logs may be created directly from the data streams or obtained through one or more compilations from one or more parties knowing or supplying information from or about the data stream. These data streams may be observed to obtain and relate data objects. As shown in FIG. 4, at step 404, a mobile device may connect to a WiFi connection. At step 406, a user may use the mobile device, such as to launch an application. The device communicates with a remote server through the application and sends data streams between the device and The server hosting the application. At step 408, the data transmissions may be directly observed or logs containing pertinent information about the data transmission may be obtained by or from the host of the application. At step 410, the desired data objects are saved with the appropriate relational weight to an exemplary spatial database as described herein.

For example, as shown in FIG. 3, a use may have configured a mobile device 310 to connect to a residential wifi signal upon detection of the signal. Therefore, when the mobile device 310 approaches or enters the house 302a, the mobile device 310 connect to the modem 312 through the wireless router. The user may then navigate on-line systems using the data transmission of the modem. When a user, for example launches and plays a game, the mobile device is broadcasting wifi, which connects within a household to the modem. The data stream sent from the mobile device to the application server includes a wifi IP address, a landline IP address, and the latitude and longitude of the mobile device received from the device GPS. The application server associated with the game provider creates a log tile of devices that are connected including the wifi IP, landline IP, and the latitude and longitude of the device. The data transmission and/or log files may be used to relate the data objects together in a relational database.

The next phase, 402, information outside of the digital exchange is correlated to the data objects received from the first phase 401. The information may be stored and retrieved through on-line databases, and may comprise information from private and public sources. For example, at step 412, the latitude and longitude saved as a data object may be used to determine a location within a parcel of land. In an exemplary embodiment, land may be subdivided into incremental units, such as foot by foot squares, or decimal places of the latitude/longitude grid. Each incremental unit may be assigned a latitude longitude or range of latitude and longitude coordinates. In an exemplary embodiment, a unique latitude and longitude coordinate is assigned to each incremental unit. When a data object is determined associated with a latitude and longitude, it may be correlated to the specific incremental unit to determine a location within a given parcel of land. At step 414, that incremental unit may be used to determine a street address associated with the latitude and longitude data object. Thus, the street address may be determined and saved in the spatial database as a data object related to the other data objects already retrieved.

In a third phase, 403, registration, log-in, and permissions data may then be used to obtain additional data objects. For example, when a user registers, downloads, or installs an application, the application may require the owner to grant certain permissions and provide personal information. The information may include account or log-in information, but may also include contact, identity, or demographic information, such as email address, physical address, mailing address, name, gender, age, etc. The information associated with the user is saved in a database by the application owner. If any piece of information is known, the user registers can be used to obtain any other piece of information about the user.

Thus, in the exemplary embodiment of the user engaging in a game application, the owner of the game application has previously saved information about the user of the game. The user downloaded the game, permitted the owner to retrieve and share certain information about the user, and may have provided additional user information such as contact, identity, or demographic information. At step 416, the system retrieve the registration logs of the associated application engaged in by the user, mid at step 418 retrieves additional data objects associated with the user from the registration logs. The additional data objects may include information such as e-mail address and physical address. These objects are saved to the spatial database or if already present, the relational weight associated to the other data objects is appropriately increased.

Phase 402 may then be continued in which additional off-line associations may be used to continue to enhance the relational data objects. At step 420, for example, the integrity of the spatial database objects may be verified through publically available information. For example, a name may be associated with physical or email addresses. These information sources may be used to appropriate alter the associated relational weight between data objects. At step 422 additional analysis of the data objects may be performed in conjunction with other information retrieve about or with the data objects to provide additional information. For examples, day parting, data object frequency, and duration may also be used to determine additional data objects or attributes associated with a given data object. Therefore, an address may be further identified or classified as a work or residential address.

Once the associations within the spatial database have been made, such that a threshold certainty regarding the particular occurrence of any data object with respect to the other data objects is known, the relationship merely needs to be looked up and verified upon subsequent use of the mobile device, wifi connection, and application. For example, at step 424 the ultimate association between the IP addresses and the physical address is desired. Therefore, when the user launches the same game application through the same wifi connection, the associated weight may be appropriately increased. However, unless desired, the entire method, including finding and associating additional data objects may or may not be performed in whole or in part. Any portion of the method may be updated to strengthen the association of any desired data object. For example, data objects that are more volatile, but desired for association, may be looked up according to one or more steps of the method and verified and/or updated. However, more static data objects may not need verification on such a regular basis. The method in whole or in part may be implemented depending on the association strength of any one or more data objects. For example, if a discrepancy or flag is created indicating one or more data objects are no longer associated with the other data objects, then that specific information may be looked up according to embodiments described herein. However, if there is no indication that a data object is out of date, for example by verifying one or more selected data objects for association, then the method steps associated with retrieving and/or confirming the remaining data objects may be skipped.

A number of companies obtain various data objects about users. For example, large data providers may compile associations of personal information including first name, last name, email address, and street address. These data providers may therefore be used to associate a known email address to a street address. From the public data providers, the association of email to street address may be incremented.

An exemplary embodiment for obtaining an email address is through personalized links sent through email. FIG. 1B illustrates an exemplary relationship created when a user sends personal links within an email. A user may incorporate a redirect Uniform Resource Locator (URL) within an email to a recipient. The URL is essentially a personal URL with a unique identifier that permits the recipient to click the link within the email browser and navigate or launch the associated website. When creating the unique URL in the email message, the server identifies the recipient email address corresponding to the sent link.

As the recipient launches the personal URL by clicking the provided link, the recipient's browser launches and opens the unique URL. As with most browser interactions, the IP address of the sending device is sent to the recipient server. Because the URL is unique and the server is aware of the original email recipient of the link, an observer of the transaction can presume that the IP address of the device navigating to the link belongs to the same user as the email address that the personal URL was sent. Accordingly, the URL is a unique URL personalized and tied to the receiving email address. As it opens in the recipient's browser, the IP address of the device as well as the email address is known to the receiving server. Accordingly, the association between the email and IP address data objects may be incremented.

From the public information of email to address association, the IP address to street address is similarly strengthened. Therefore, even though the IP address never was directly observed relative to the street address, the association of the street address to IP address is created through the email address.

In many interactions between users and companies or applications, the user must log in or register to use one or more services or applications. The on-line form is very common to identify personal information, such as name, address, and email. As with other internet data transmissions, the device IP address is generally communicated along with the other data entered on the registration or associated form. Therefore, every time a user fills a form or registers with a provider, that provider data may be used to increment respective data objects such as email address to street address within the spatial database. As the IP address is transmitted with the registration information or may be seen with the saved form fill fields, the IP address may similarly be incremented or associated to street address or other known data objects.

Cache ID is a unique token that permits the browser to identify a user. In an exemplary embodiments cache ID may be created and used to verify a user when creating a secure connection. Online security companies that transition the browser between the public protocol (such as http://) to the secure protocol (such as https://) identify a user through a unique token created by the web server and saved to the user's browser.

As a user logs into a website, the browser and web server create a secure connection by verifying the token exists and matches for the selected user. A unique URL is used each time to locate and create the secure connection between the same user and provider, in which the same token is used to authenticate the respective identities. Therefore every time the connection is made, the same unique data bit string identifying the unique URL will be transmitted to access and create the secure connection. Similar to other browser transmissions, the IP address of the sending device is also transmitted. Therefore, a unique bit string identifying the unique URL is transmitted or can be associated with the IP address of the device. The token therefore relates both the unique URL and the cache ID. As seen in FIG. 2, the unique URL 220, identifier token 222, and cache ID 210 associated with the secure connection are therefore related and the associated incremental weight is appropriately incremented with respect to the IP address 212b of the device.

The cache ID can be readily cleared by a user by resetting their cache and/or browser folders or associated browser information. However, the unique URL is a more static identifier associated with the secure connection. Therefore, even if a user clears the previous cache ID folders, the association between the unique URL of the secure transaction and the newly provided cache ID can decrement or remove the relationship of the previous cache ID to the associated unique URL and identifier token, while substituting, adding, or incrementing a relationship to the new cache ID.

The cache ID can also be observed in transactions in which advertisements are delivered to a browser. For example, companies that deliver rich media video banner advertisements, or motion banners, observe and identify cache IDs saved to a users computer. The advertisers may use the cache IDs to identifier users to receive specific advertisement opportunities. Therefore, whenever a banner is presented on a website, the cache ID is generally retrieved to identify users for these particular opportunities. As with other web traffic, the IP address is similarly identified when transmitting or logging the retrieved cache ID. Therefore, through the unique cache ID, an association can be made to the user's IP address.

The cache ID associated with a device may be changed as the device changes networks. Therefore, a series of cache IDs may be used to identify the same user and/or same device across various networks and associated IP addresses. As such, the cache ID and associated unique URL may provide two additional semi-persistent and persistent identifiers to relate a user across devices, networks, and locations.

Similar to the token used to identify a user for the secure connection, cookies are saved and used by various companies to identify a user and monitor activity of that user on their and associated websites. For example, cookies are used to save information about a user for the auto-form filling feature of internet form. Therefore, cookies may associate a name, address, and email to a particular user on a device. The cookie ID is sent with the IP address when accessing the associated website and is also saved in the web registration logs for the owner of the website. Accordingly, as seen in FIG. 2 the device IP address 212c is related to the street address 202 through the cookie value 206.

Cookies may be used to identify if a user visited specific websites, as each website likely has its respective cookie saved to the user's cookie folder. Therefore, activity profiles of a user can be generated from observing cookie IDs.

Similar to the cache ID, companies may attempt to engage a consumer on other websites by providing their cookie ID to the host or to advertisers displaying on a host website. Therefore, the IP address is observed with one or more cookie IDs each time the user browses a site that has advertisement or other opportunities linked to the cookie ID.

Other unique set of persistent or semi-persistent identifiers may be tied to a specific device and used to create other data objects within the spatial database. For example, device ID which uniquely identifies a device may be related to an IP address and used to identify or relate other information pieces passed or logged with the device ID.

Another exemplary persistent identifier is an identifier of a hardware or chipsets that is typically stored in firmware. For example, the video card ID of a video card display adaptor is associated through the firmware. In an effort to identify actual users as opposed to botnets, companies may poll the video card of a device to observe and compare one or more pixels to determine whether the display hardware is actually displaying an image to a device screen. If various pixels are lit, indicating different color combinations, then it can be assumed that an actual viewer is observing the screen. The display request is therefore not an automated request sent by a botnet and not a user. When the display hardware is polled, a unique video card ID is transmitted with the return information. Therefore, the video card ID can be associated with the device IP address for that data transmission. For example, whenever a program needs to access the display, such as a flash player, the unique identifier stored in firmware is included in the transmission and can be related to other identifiers of the transmission.

Therefore, one or more methods, systems, and devices may be used to identify one or more persistent or semi-persistent identifiers regarding a user, device, household, or related information. From these, one or more persistent and semi-persistent identifiers, other information about the user, device, or household may be obtained. Semi-persistent or semi-permanent identifiers are used interchangeably and include any identifier that are re-used to identify or relate to the same user, device, or source in more than one unrelated data exchange or session. However, the identifier may be changed. The change for a semi-persistent identifier may occur without too much difficulty, such as by power outage, unplugging a device, resetting a device, clearing folders, etc. For example, Cookie value, IP address, and cache ID are exemplary semi-persistent identifiers as they can be easily reset by a user at any time, but are generally used between different internet sessions to identify the same source. Persistent or permanent identifiers are those that are associated with a user, device, or object over an extended period of time through multiple unrelated data exchanges or sessions. The persistent or permanent identifiers are used interchangeably as those identifiers not typically changed by natural occurrences or typical users. For example, device IDs, street addresses, latitude/longitude coordinates, video card IDs are exemplary persistent identifiers. These identifiers may be changed, but not nearly as easily as the semi-persistent identifier. For example, an entire machine may be reprogrammed or an area redeveloped, but the alteration typically requires a complete rebuild or reconfiguration of the associated object of the identifier.

The persistent and semi-persistent identifiers may be obtained through different and unrelated interactions by the user over a device. For example, data objects may be obtained from observing the data transmission of a user interacting with a given program or application. Data objects of the same or different values may be obtained from various other sources and activities of a user, such as, for example, observing the information supplied by a user when registering or logging into online activities; public records; or navigating to or using personal or unique URLs through secure connections or personalized emailed links.

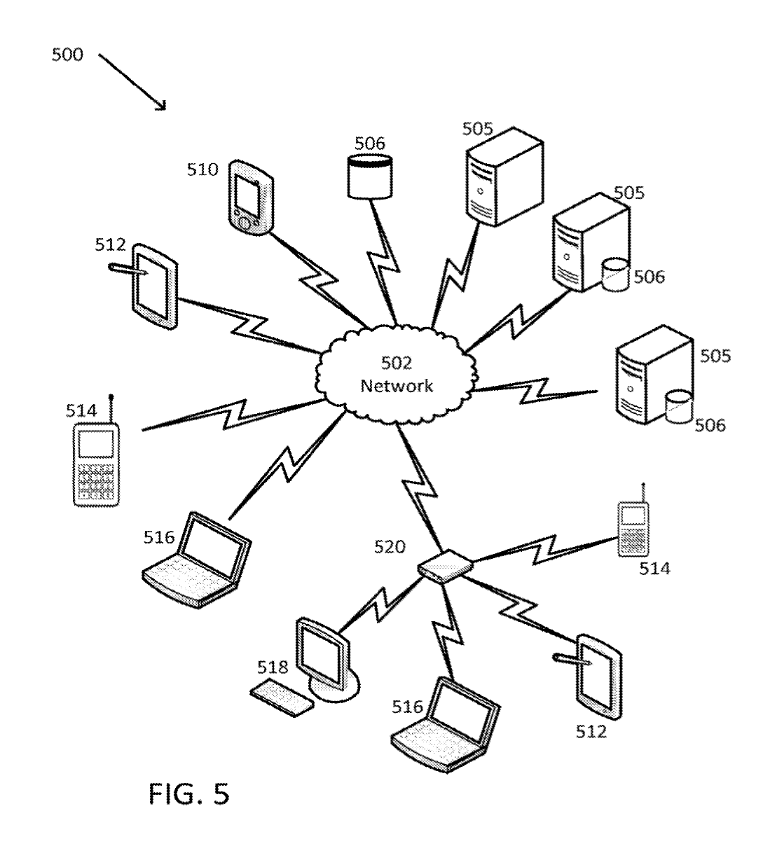

FIG. 5 illustrates an exemplary diagram of an embodiment of a client-server network environment 500 to implement embodiments described herein. The network 502 is used to connect multiple devices of one or more users. The devices may connect directly to the network 502 or through a modem 520. The devices may include, for example, mobile devices, such as smart phones 514, tablets 512, laptop 516, or other portable devices 510 and generally non-mobile devices, such as desk top computers 518. The network 502 connects the devices to servers 505 that provide information to and from the devices from databases 506.

An application resident on a client device, such as devices 510, 512, or 514, or executed through a browser such as through devices 514, 516, and 518, communicates over the network 502 with the one or more servers 505 and their databases 505. This client device-server system is configured to enable a user of the client devices to conduct one or more transactions over the internet. For example, the user may search the internet for information, purchase items through one or more vendor websites, receive news feeds, etc. The client devices may have a downloadable application running resident on the device and communicating across the network, or may execute an application through a browser scripted to run one or more programs that interact over the network.

An exemplary server 505 receives one or more pieces of user information associated with the user and/or transaction. The server may keep a profile of the one or more pieces of data or information. One or more modules may be stored as non-transitory machine executable code on memory coupled to the network. The code may be executed by a processor to perform the functions of the module. Exemplary modules may also be any combination of hardware or software to perform the described functions.

A module, such as a client application on the mobile client device or server applet resident on the server and run on a client browser, may be configured to receive one or more pieces of user information. The module may communicate over the network, such as the internet, to the server, which stores the information in a database. One or more modules may then use the information to perform the algorithms described herein. The server applet works with a browser application resident on the client device and serves one or more web pages to the client device with the resident browser.

While some specific embodiments of the invention have been shown the invention is not to be limited to these embodiments. For example, most functions performed by electronic hardware components may be duplicated by software emulation, and vise-versa. Thus, a software program written to accomplish those same functions may emulate the functionality of the hardware components in input-output circuitry. The invention is to be understood as not limited by the specific embodiments described herein, but only by scope of the appended claims. For example, specific embodiments include modules performing one or more functions. These functions may be performed by one or more other modules, integrated into the same module, or recombined into any combination available.

Embodiments as described herein for identifying and relating data objects may be used to achieve a number of advantages over conventional identification systems, such as storing and retrieving cookies by individual users or other forms of IP targeting and addressing.

The spatial database including one or more of the data objects may be accessed to output a fiat file that is typical of a table or relational database, including the data objects of interest. The data objects in the flat file may include those objects of interested related by a sufficient confidence level of association. Therefore, once a data object has been related a sufficient number of times or by independent or different sources, then the data object may be outputted to the flat file as sufficiently relating to other data objects of the flat file.

In an exemplary application, the flat file of desired data object values may be updated or outputted at a determined increment to provide reasonably up to date information about the related objects. The interval may be, for example, every 15 or 30 minutes, every hour, or every day. The flat file permits the associated data to be accessed in a smaller file format, which can be stored and searched faster or more efficiently than the spatial database. Therefore, for applications limiting bandwidth or server speed for computations, the flat file can provide the information obtained from the spatial database without the associated bandwidth and speed requirements. The flat file may serve the basis of the segmented database 108 illustrated in FIG. 1A.

Outputting a flat file from the related data object of the spatial database also permits encryption of the dataset to requesting parties. For example, when the flat file is updated periodically, one or more fields may be encrypted or hashed such that a key, value, or function is used to interpret the data in the flat file. Therefore, the key, value, or function may change between flat files, such that an observer that may encounter sequential flat files does not see a recurrent association between one data object, such as the IP address, and a unique character set representing the data associated with or encrypting the related object, e.g. physical address. Therefore, even if the encrypted or hashed value is unknown, it cannot be used by another party as a unique identifier or recurrent identifier associated with IP address. A user of the dataset originating from the spatial database must continually receive the key, value, or function to decrypt or decode the hash and obtain the desired value associated with provided information, i.e. the postal address of the given example.

If the flat files are extracted and stored on the server side of a transaction, the desired information can be pre-identified, or pre-stored relative to an IP address. When an IP address is sent with a data transmission, the website or receiving server can immediately look up additional or desired information about the user and/or device. Therefore, transactions with a user do not need to request access or receipt of additional information, such as the cookie index, which takes additional time to access, sort, and retrieve the relevant identifiers. Instead, the server may directly identify a user from the IP address.

Traditionally, the device ID or cookie is used to identify a specific device or user. However, such identification is inefficient. For example, with respect to these identifiers, it generally takes longer than 120 milliseconds to retrieve or obtain the desired identifiers and then decide or relate the needed information to that identifier. Similar methods of retrieving, reviewing, and comparing external server logs, or external connection requests or identifying users, devices, or connections, generally take longer than 120 milliseconds. Accordingly, companies cannot make the requisite decisions regarding a user within the time frame provided to make those decisions. In the context of advertising, an advertiser is generally provided 120 milliseconds to decide to serve an ad or bid on an advertising opportunity for a user. If the user cannot be identified quickly enough, the advertiser must make uninformed decisions regarding whether they will serve and pay for an advertisement to a user.

Specifically, generally the IP address is the first or one of the first data transmissions inside of an exchange. Therefore, when an information packet is sent from a website at the internal server, the IP address is generally used to establish the connection. Accordingly, the IP address is obtained within picoseconds without requesting or requiring additional communication between the device and server. If a user is directly identified by the IP address or the relevant desired information is associated directly with the IP address, the relevant data can be retrieved quickly without requesting additional information and taking the additional time to retrieve and identify the desired information from the device.

The spatial database may also be used to relate different devices together through the same physical location. For example, when relating the mobile device through the household modem, the mobile device, such as a cell phone or tablet, the device is identified with a relation to both the modem IP address of the residence as well as the postal address of the residence. Therefore, for example with respect to FIG. 2, the mobile IP address 212b is related to the modem IP address 212a and the postal address 202. Whenever a laptop, desktop, smart TV, or other device similarly connects through the same modem IP address 212a, the device IP address 212c of the respective device will be related to the mobile IP address 212b though that same modem IP address 212a. Therefore, the entire or substantial portion of the internet available devices of a given residence can be identified and related together.

Because each of the devices connected to a particular IP address are known, the patterns of where those devices go onto other networks can also be observed and related as well. From this information, the devices associated with particular users instead of related users can be distinguished or identified.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A method of determining a first piece of information about a user from on-line activities, the method comprising:
associating the first piece of information and a second piece of information together, wherein the second piece of information and the third piece of information occur together in a record log;
associating the second piece of information and a third piece of information together, wherein the second piece of information and the third piece of information occur together during a single on-line event of the user; and
determining the first piece of information when the third piece of information is identified in an on-line event of the user because of the association through the second piece of information, wherein the first piece of information is not available from information exchanged during the on-line event.

2. The method of claim 1, wherein the record log is from off-line activities.

3. The method of claim 1, wherein the record log is created from information exchanged during a first on-line event.

4. The method of claim 3, wherein the first piece of information is a physical address.

5. The method of claim 5, wherein the third piece of information is an internet protocol address.

6. The method of claim 5, further comprising storing the first, second, and third pieces of information in a relational database.

7. The method of claim 6, wherein the relational database is a spatial database.

8. The method of claim 6, further comprising exporting a flat file of first, second, and third pieces of information, wherein the determining the first piece of information is retrieved from the flat file with a look up to the third piece of information.

9. A method of relating a physical address of a user and an IP address of a user from on-line exchanges of the user, the method comprising:
relating an IP address to an intermediate identifier, where the intermediate identifier is observed with the IP address during a single on-line exchange;
relating the physical address of the user to the intermediate identifier after an observed correlation between the physical address and the intermediate identifier; and
relating the physical address of the user and the IP address of the user, where the physical address and the IP address are not observed together in a single on-line exchange.

10. The method of claim 9, further comprising associating latitude and longitude coordinates to a postal address, wherein the postal address corresponds to set of latitude and longitude, the latitude and longitude coordinates occurring within the set of latitude and longitude, wherein the physical address is the postal address and the intermediate identifier is the latitude and longitude coordinates received from a GPS of a mobile device of the user.

11. The method of claim 10, further comprising associating the postal address with a time the user is at the postal address.

12. The method of claim 11, further comprising using day-parting, frequency of occurrence, and duration from the time associated with the postal address to determine a relationship of the postal address to the user.

13. The method of claim 11, further comprising using the time association to determine that the postal address is a work address or residential address of the user.

14. The method of claim 10, wherein the IP address is of a mobile device of the user, the method further comprising correlating an IP address of a modem, the IP address of the mobile device connected to the modem, and latitude and longitude coordinate received from the mobile device when the mobile device is connected to the modem, wherein the IP address of a modem, the IP address of a mobile device, and the latitude and longitude coordinate were sent together during an authentication of the mobile device when connecting to the modem, wherein the latitude and longitude coordinate is the intermediate identifier.

15. The method of claim 14, further comprising determining the postal address from the latitude and longitude coordinates received from the mobile device to relate the user's IP address to the postal address associated with the user, the postal address is the physical address.

16. The method of claim 9, further comprising correlating the user email and the user IP address after the user had received a redirect Uniform Resource Locator (URL) from a received email and after the user clicked on the URL, wherein the user email is the intermediate identifier.

17. The method of claim 16, further comprising determining the postal address from off-line public records associated with the user email to relate the user IP address to the postal address, wherein the postal address is the physical address.

18. The method of claim 9, further comprising correlating the physical address of the user, an email address of the user, and IP address of the user, where the physical address and the email address were entered by the user during an on-line registration on a machine having the IP address.

19. The method of claim 10, further comprising correlating a unique URL, cache ID, and IP address after the unique URL, cache ID, and IP address were exchanged together when creating a secure on-line connection between a machine of the IP address to a remote server or computer.

20. The method of claim 10, further comprising correlating a video card ID and IP address after the video card ID and IP address were sent in a same on-line exchange.

21. The method of claim 9, further comprising relating a second identifier to the IP address of the user after the second identifier and the IP address have had an observed correlation, using the second identifier to update a value of the intermediate identifier after the intermediate identifier and the second identifier have had an observed correlation.
